(19) United States
(12) Patent Application Publication
(10) Pub. No.: US 2024/0161739 A1
(43) Pub. Date: May 16, 2024

(54) SYSTEM AND METHOD FOR HYBRID GENERATION OF TEXT FROM AUDIO

(71) Applicant: Verbit, Inc., New York, NY (US)

(72) Inventors: Roman HIMMELREICH, Jerusalem (IL); Eli ASOR, Tel Aviv (IL); Elad SHTILERMAN, Aseret (IL); Dmytro YATSYNA, Kyiv (UA)

(21) Appl. No.: 17/987,439

(22) Filed: Nov. 15, 2022

(51) Int. Cl. G10L 15/187; G10L 15/06; G10L 15/22

(52) U.S. Cl. CPC G10L 15/187; G10L 15/063; G10L 15/22; G10L 2015/0635; G10L 2015/0638

(57) ABSTRACT

A method, system and computer program product, the method comprising: obtaining an audio signal; processing by an automatic speech recognition (ASR) engine a part of the audio signal shorter than the audio signal, to obtain a partial text representing the part of the audio signal, said processing performed in accordance with an ASR model; providing the part of the audio signal and the partial text to a reviewer; assembling an ASR model update, based on input from the reviewer; applying the ASR model update to the ASR engine; and processing at least a second part of the audio signal by the ASR engine using the ASR model as updated, to obtain a further partial text of the audio signal.

### TECHNICAL FIELD

The present disclosure relates to transcribing audio in general, and to a system and method for a hybrid approach to generating text from audio, in particular.

### BACKGROUND

Tremendous amounts of audio and video contents are constantly generated all over the world, to be consumed on different platforms, such as television broadcasts, network broadcasts, social network posts, or the like. It is required to transcribe the speech parts of the audio and the video or significant parts thereof, in particular content that is broadcast on television networks. Comparable transcription requirements arise in other contexts, including education (such as virtual classrooms), scientific conferences, legal proceedings, or the like. Such need may arise from accessibility requirements for deaf or hard of hearing people such that they can read the titles or captions, from a requirement to translate the speech to a local language, or for other purposes.

Speech recognition has seen a huge advancement in recent years. However, generally speaking, the quality of automatic transcription may still be unsatisfactory in some situations. For example, where there is a standard with which the transcription quality needs to comply, such automatic transcription may not be acceptable as is.

### BRIEF SUMMARY

One exemplary embodiment of the disclosed subject matter is a computer-implemented method for transcribing audio signals, comprising: obtaining an audio signal; processing by an automatic speech recognition (ASR) engine a part of the audio signal shorter than the audio signal, to obtain a partial text representing the part of the audio signal, said processing performed in accordance with an ASR model; providing the part of the audio signal and the partial text to a reviewer; assembling an ASR model update, based on input from the reviewer; applying the ASR model update to the ASR engine; and processing at least a second part of the audio signal by the ASR engine using the ASR model as updated, to obtain a further partial text of the audio signal. The method can further comprise maintaining a buffer of the audio signal processed by the transcriber and not yet provided to the reviewer, the buffer being of a duration of at least a first threshold to ensure that a transcribed part is available to the reviewer. The method can further comprise maintaining a buffer of the audio signal processed by the transcriber and not yet provided to the reviewer, the buffer being of a duration of at most a second threshold, to enable processing of further parts of the audio signal by the ASR engine as updated. Within the method, the reviewer optionally comprises one or more humans. Within the method, the reviewer optionally comprises two or more human reviewers, and the input from the reviewer optionally comprises text updates from the human reviewers. Within the method, the text updates optionally relate to one or more words misrecognized by the transcriber. Within the method, the text updates optionally relate to one or more items selected from the group consisting of: one or more words recognized by the transcriber not frequently enough; one or more spelling corrections, one or more words pronunciation corrections, and one or more words formatting corrections. Within the method, the partial text is optionally corrected by the reviewer to obtain a corrected text. Within the method, the ASR model update is optionally retrieved automatically from the corrected text. Within the method, upon receiving the update ASR model or upon completion of review of the at least one part by the reviewer, the ASR engine optionally transcribes at least an additional part of the audio signal. The method can further comprise applying said processing, said providing, said obtaining and said applying to further parts of the audio signal. Within the method, said processing optionally comprises transcribing the part of the audio signal or generating captions for the part of the audio signal. The method of can further comprise providing the ASR model update by an automated process using an Application Program Interface. Within the method, the ASR model optionally comprises one or more items selected from the group consisting of: a language model, a specific vocabulary model, an acoustic model, a pronunciation model, and a combination of two or more of the above.

Another exemplary embodiment of the disclosed subject matter is a system having a processor, the processor being adapted to perform the steps of: obtaining an audio signal; processing by an automatic speech recognition (ASR) engine a part of the audio signal shorter than the audio signal, to obtain a partial text representing the part of the audio signal, said processing performed in accordance with an ASR model; providing the part of the audio signal and the partial text to a reviewer; assembling an ASR model update, based on input from the reviewer; applying the ASR model update to the ASR engine; and processing at least a second part of the audio signal by the ASR engine using the ASR model as updated, to obtain a further partial text of the audio signal. Within the system, the processor is optionally configured to maintain a buffer of the audio signal processed by the transcriber and not yet provided to the reviewer, the buffer being of a duration of at least a first threshold to ensure that a transcribed part is available to the reviewer. Within the system, the processor is optionally configured to maintain a buffer of the audio signal processed by the transcriber and not yet provided to the reviewer, the buffer being of a duration of at most a second threshold, to enable processing of further parts of the audio signal by the ASR engine as updated. Within the system, the reviewer optionally comprises two or more human reviewers, and wherein the input from the reviewer comprises text updates from the two or more human reviewers. Within the method, the text updates optionally relate to one or more items selected from the group consisting of: one or more words misrecognized by the transcriber; one or more words recognized by the transcriber not frequently enough; one or more spelling corrections, one or more pronunciation corrections, and one or more formatting corrections.

Yet another exemplary embodiment of the disclosed subject matter is a computer program product comprising a non-transitory computer readable medium retaining program instructions, which instructions when read by a processor, cause the processor to perform: obtaining an audio signal; processing by an automatic speech recognition (ASR) engine a part of the audio signal shorter than the audio signal, to obtain a partial text representing the part of the audio signal, said processing performed in accordance with an ASR model; providing the part of the audio signal and the partial text to a reviewer; assembling an ASR model update, based on input from the reviewer; applying the ASR model update to the ASR engine; and processing at least a second part of the audio signal by the ASR engine using the ASR model as updated, to obtain a further partial text of the audio signal.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 is a schematic illustration of an environment for generating text from audio;

FIG. 2 is a schematic illustration of an enhanced environment for generating text from audio, in accordance with some exemplary embodiments of the disclosed subject matter;

FIG. 3 is a flowchart of steps in a method for generating text from audio, in accordance with some exemplary embodiments of the disclosure; and

FIG. 4 is a block diagram of a system for generating text from audio, in accordance with some exemplary embodiments of the disclosure.

### DETAILED DESCRIPTION

One technical problem dealt with by the disclosed subject matter relates to the difficulty of providing transcription of audio, wherein the transcription needs to be of high quality on one hand, but at an affordable price on the other hand. The quality may be measured, for example, in the number of errors per time unit of the source media. In some situations, for example when content is broadcast soon after it is created, the transcription also needs to be available at an acceptable delay after the audio becomes available, for example not exceeding a predetermined delay.

A known practice is to transcribe the audio using an Automated Speech Recognition (ASR) engine, followed by review and optionally correction of the text as output by the ASR engine. The review may be performed by a human reviewer, by a second ASR engine which may be different from the first one, or the like.

If the time when the transcription is available is of importance, for example when transcribing ongoing events, it may be required to reduce the delay and not postpone the transcription to when the whole audio is available. For that purpose, once an audio segment of a predetermined duration is available, the audio may be provided to the ASR engine to be transcribed, optionally followed by the text being reviewed and corrected. In some embodiments, the transcribed audio and the automatic transcription may be split between two or more reviewers to expedite the review and make the enhanced transcription available shortly after the audio has been obtained. By the time some or all of the reviewers have finished reviewing their assigned audio segments, a subsequent part of the audio may be available and transcribed by the ASR engine, such that the reviewer(s) can proceed to review it with the associated transcription.

However, in such a flow, although the audio is processed in parts, the engine is not adapted, and the quality of the ASR transcription is not improving while the session is going on. In particular, if the audio contains words, terms or phrases that do not appear in the language model used by the ASR engine, or are infrequent in the language, recognition of the terms will not improve as the audio continues. For example, in an audio related to a certain medical subject, relevant medical terms may appear frequently, which may be erroneously recognized throughout the audio. Thereby the reviewers' job will not become easier as the audio progresses; rather the same errors may keep appearing, and the reviewers will not only have to correct them, but may also become impatient or irritated, which may further decrease their performance in terms of efficiency and/or quality. In a similar manner, other errors, such as but not limited to erroneous phonemic transcription for one or more words cannot be corrected.

In some embodiments, it may not be practical for the ASR-created output to be corrected by reviewers prior to being presented to, for example, a TV audience watching a live broadcast. In such circumstances, improving the quality of the ASR engine by corrections provided by reviewers would be beneficial insofar as the improved ASR engine provides higher-quality output for later portions of the media or future broadcasts.

A similar technical problem may arise when adapting the ASR engine at a too early stage, when not all (and not a majority of) the new words or terms have been introduced. This may have an effect similar to no adaptation, being a transcription of lesser accuracy.

Another technical problem is the lack of synchronization between splitting the audio into parts, the automatic transcription, and the reviewers' working time, wherein the audio and the corresponding automatically-generated transcription may be reviewed a long time after it has been transcribed by the ASR, thereby causing a long delay in the availability of the enhanced transcription. In other situations, such mis-synchronization may lead to idle time of the reviewers and thus to increased transcription costs, fatigue, irritation, or other negative impacts.

One technical solution comprises a method and system for transcribing audio, comprising an engine and one or more model, such as a language model optionally comprising a vocabulary and optionally comprising probabilities for different words from the vocabulary to appear, an acoustic model, or the like. The engine may learn from corrections introduced by reviewers to segments of the audio that have already been transcribed, such that the transcription accuracy may improve as the audio progresses. Further, the delay in which the transcription of each part of the audio is available after the audio is available may be balanced against the improvement in the trained model, to obtain overall improved performance relative to currently available solutions.

The solution is especially useful to relatively longer audio streams. For example, for an audio stream that is 30 minutes in length or longer, the solution may comprise splitting the audio signal into parts, for example of five minutes each. The first part may be transcribed by an ASR engine, and then split between a plurality of reviewers, such that each reviewer receives a part of the audio, for example each reviewer receiving one minute of audio, and the corresponding transcription. The reviewers may correct the automatic transcription, or may only indicate misrecognized words, or words that have higher probability to appear in the audio than in other audio streams and add them to the vocabulary of the language model or update other components of the ASR engine such that these words will be better recognized. The output provided by the reviewers may introduce new words to be added to the recognized vocabulary and their respective probability, or enhanced probabilities for words or word combinations already existing in the vocabulary. In some embodiments the solution may also be useful for embodiments where a short turnaround time is required, such as a video or audio that is to be broadcast shortly after being taken.

If the reviewer provides corrections to the text, then the misrecognized words, or the words whose probability may differ from the content of standard audio streams, may be retrieved automatically. Corrections to the text may include misrecognized words, words recognized at wrong probability, spelling corrections, pronunciation corrections, formatting corrections or the like.

While the reviewers are working, a second part of the audio signal may be processed by the ASR engine, such that when a reviewer has finished the assigned segment(s), the reviewer can continue with another part of the audio signal.

The term ASR model used in this disclosure is to be widely construed to cover any one or more models or combinations thereof used by an ASR system, such as but not limited to a language model, a specific vocabulary model, an acoustic model, and a pronunciation model. In some embodiments, the ASR model may be implemented as an end-to-end Deep Neural Network (DNN).

The corrections or other output by the reviewers may be collected from a plurality of the reviewers, and used for improving the one or more components of the ASR model of the ASR engine. The amended ASR model may thus contain words that have been initially misrecognized by the ASR engine, and in particular words that are unique to the audio, for example specific medical or scientific terms, terms specific to another domain, names, words borrowed from other languages, or the like. The amended ASR model may also indicate probabilities or frequencies of one or more words to appear in the audio, including for example probabilities for words that may be present in everyday talk but appear at higher frequency or in different contexts in the audio stream, for example names of countries, car parts, or the like. The expected probability may be indicated using any scale, such as times per minute, percentage of the words, a scale of 1-5 wherein 1 is a low probability and 5 is high, 1-10 scale, or the like. The probability may be deduced, for example, from the number of appearances of a word in an audio segment which may be higher or significantly higher than its probability in standard audio streams.

The change in ASR model will only begin to affect the automatic transcription after being applied to the ASR system. However, transcribing the second part while the reviewers are still working on the transcription of the first part enables the reviewers to work on further audio segments immediately after finishing the first part, while minimizing idle time in-between. It is appreciated that there is an inherent tradeoff between minimizing the ide time of the reviewers (which provides for fast turn-around time), and delaying the automatic speech recognition as much as possible, in order to enable the latest possible updates to the ASR model.

The process may repeat, with the ASR engine transcribing part x using the updated ASR model as based on the corrections accumulated from the reviews of parts 1 . . . x−2 (or some portion thereof), while the reviewers are working on part x−1.

It is appreciated that the parts of the audio stream are not necessarily of uniform length. Rather, the first parts transcribed by the ASR engine may be shorter while later parts may be longer. For the earlier parts, it may be desired for the model to be updated relatively early in order to recognize relevant unique terms that are frequently-used in the audio. For later parts, the model may not change as much, since at least some of the vocabulary prominent in the audio stream has already been expressed and may remain more stable relative to the variation between the audio stream and “general” audio streams. In addition to improving the recognition accuracy, increasing the durations of the later parts may also reduce the overhead of splitting the stream into parts, splitting each part between reviewers and integrating the reviewed text to provide the output.

One technical effect of the disclosure provides for a system and method for outputting high accuracy transcription of audio, by combining fast automatic transcription by an ASR engine, with one or more further reviews, performed by a human or by a different automatic transcription component, which may be slower or more expensive and which may be realized using separate hardware and/or software), or the like. The automatic transcription accuracy is improved while the audio stream is being processed, by updating the used ASR model based on the corrections or indications by the reviewers based on earlier parts of the audio signal, such that the engine learns and improves over time. It is appreciated that further improvements may be introduced, such as a different breakdown of a word into phonemes. This may allow the ASR engine to recognize words which were unrecognized in earlier parts of the audio signal, or to improve the recognition of some of the words that may have lower probabilities in the general ASR model. By introducing one or more updated models based on accumulated parts of the audio stream, the automatic transcription quality is improved, thereby enabling the reviewers to complete their review of further parts faster or with lower effort.

Another technical effect of the disclosure provides for synchronizing the timing and the length of the parts provided to the ASR engine which are then provided to the reviewers, such that the ASR model will improve based on output of the reviewers, while the reviewers will not be idle and as long as the audio stream is not fully transcribed, there will always be another part for them to work on, or, at least, the idle time is reduced and utilization rate is improved.

Yet another technical effect of the disclosure provides for improving the accuracy of the ASR engine, by delaying the automatic transcription of segments of the audio as much as possible, such that the engine will operate with a model that contains the latest possible corrections by the reviewers. Synchronizing the automatic transcription audio with the work of the reviewers and with updating the language model provides for combining the effects above, including on-going improvement of the transcription accuracy as well as high utilization of the reviewers' time.

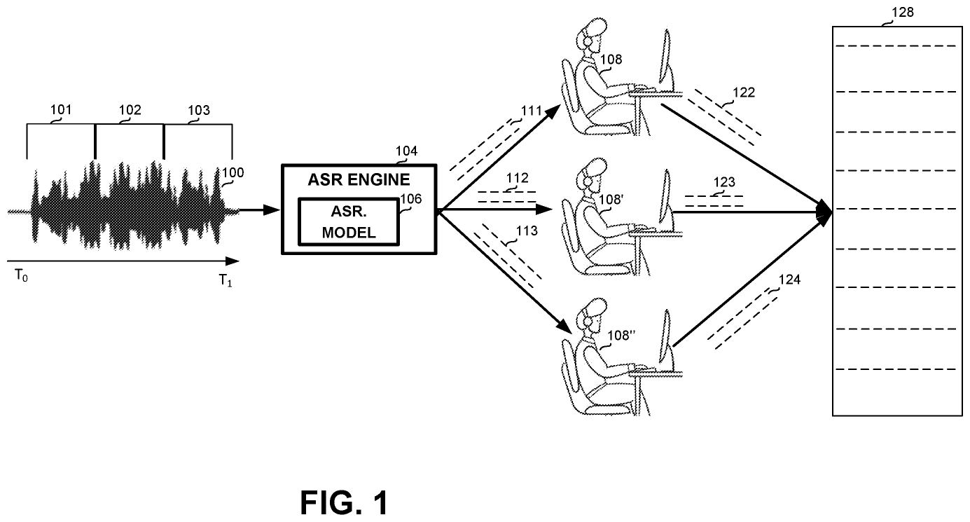

Referring now to FIG. 1, showing a schematic illustration of an environment for generating text from audio.

In the environment, audio signal 100 may be provided. Audio signal 100 may be captured, for example from one or more audio capture devices such as a microphone, a microphone array, or any other and transformed to a digital signal. Audio signal 100 may be pre-captured and provided digitally from a storage device such as a disk, downloaded or streamed over a network or the like. Audio signal 100 may be of a time duration between T₀ and T′, for example 10 minutes, one hour, two hours, or the like.

Audio signal 100 may be input into a transcriber which may be an automated process such as an ASR engine 104, for transcribing audio signal 100 and outputting text. ASR engine 104 may implement any relevant algorithm, such as but not limited to hybrid DNN-HMI based decoding, pure DNN based decoding, or the like. ASR engine 104 may operate in accordance with ASR model 106, in which the language model part represents an initial vocabulary comprising words and probabilities for one or more words expected to be found in audio signal 100. The language model may be general, application specific or domain specific, for example comprising more terms from a specific field than usual or higher probability for these terms to appear. The field may relate to any subject, such as medicine, sports, geography, politics, or the like, or any sub-field thereof, such as cardiology, basketball, etc.

ASR engine 104 may output the text wherein each word or phrase may be associated with a timestamp indicating the location of the word or phrase within the audio.

The text and the audio may then be provided to one or more reviewers. The reviewers may be human, a computerized system such as another ASR engine, or the like.

If multiple reviewers are available, the work may be distributed therebetween. In the exemplary environment of FIG. 1, the first segment 101 of audio signal 100, together with the relevant text 111 representing the automatic transcription of segment 101 as provided by ASR engine 104 may be provided to reviewer 108, the second segment 102 of audio signal 100, together with the relevant text 112 representing the automatic transcription of segment 102 as provided by ASR engine 104 may be provided to reviewer 108′, and the third segment 103 of audio signal 100, together with the relevant text 113 representing the automatic transcription of segment 103 as provided by ASR engine 104 may be provided to reviewer 108″.

In some embodiments, there may be certain overlap between the segments assigned to different reviewers. For example, segments of the audio known to contain speech by a recognized important figure may be reviewed by two or more reviewers to ensure accuracy. It will also be appreciated that some segments, for example commercials may go unreviewed.

Each reviewer may correct the text as received from ASR engine 104 and assigned to the reviewer.

The text output by the reviewers may be unified in accordance with the order of the audio segments provided to the reviewers, for example, output 121 by reviewer 108 who received segment 101 may go first, then output 122 by reviewer 108′ who received segment 102, and then output 123 by reviewer 108″ who received segment 103, to generate a complete reviewed text 128 representing audio signal 100 from time T₀ to time T′.

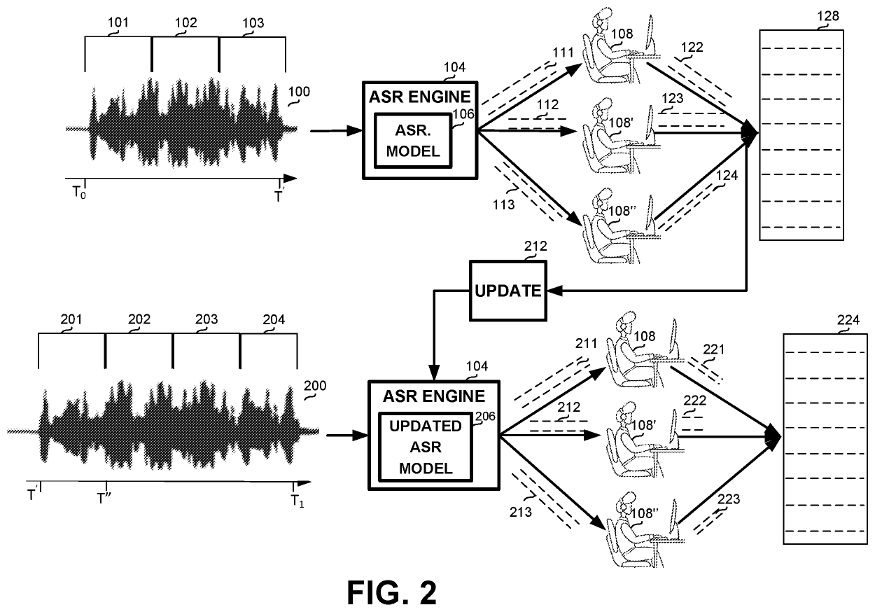

Referring now to FIG. 2, showing a schematic illustration of an environment for generating text from audio, in accordance with some exemplary embodiments of the disclosure.

At a first stage, an initial part of the audio is processed as described in association with FIG. 1 above.

While the reviewers are working on segments 101, 102 and 103 and the associated transcription, ASR engine 104 may continue transcribing the audio signal, for example segment 201 from T′ to T″, such that once any of the reviewers has finished the assigned task, the reviewer can continue with a part of audio 201 and the associated transcription.

Additionally, the corrections made by the transcribers, as reflected in texts 122, 123 and 124 may be processed to generate an update 212 to ASR model 106 or to any component thereof. Update 212 may comprise words or phrases that have been misrecognized in segments 101, 102 and 103. Update 212 may also comprise updated probabilities of one or more words or phrases to appear within the audio.

Depending on the specific implementation, update 212 may then replace, or be integrated into ASR model 106 to generate an updated ASR model 206. In some implementations, the new words, terms and phrases may be added to the language model. In another implementation, a new ASR model may be created upon the corrected texts, upon newly added labels related to any aspect of the audio such as accent pronunciation or others, or the like, with or without additional information, such as additional texts, followed by combining the existing model and the newly created model. In yet another implementation, which may be less preferred since training may take a long time and thus increase the utilization and the turn-around time, the ASR model may be re-estimated from scratch with the new and existing terms, texts or other information.

In some embodiments, the vocabulary may be updated by any other process, using an Application Program Interface (API) provided for such updates. For example, the vocabulary may be updated based on previously obtained text related to the same subjects.

ASR engine 104 may continue to transcribe further segments of audio signal 100, for example from T″ to T₁. Once the language model has been updated, the transcription by ASR engine 104 will use the updated ASR model 206, to produce transcription 211, 212 and 213 of the corresponding subparts 202, 203, 204, wherein the transcription is expected to be of higher accuracy with regard to the media stream than transcriptions 111, 112 and 113.

Transcriptions 211, 212 and 213 may then be provided to reviewers 108. 108′ and 108″, whose corrected texts 221, 222 and 223, respectively, are now expected to have fewer corrections than texts 122, 123 and 124, due to the usage of updated ASR model 206. Corrected texts 221, 222 and 223 may then be appended to previously generated text 128, to provide text 224.

It is appreciated that the process may repeat, wherein ASR engine 104 continues to transcribe part of the audio while reviewers 108, 108′ and 108″ review the previously output transcriptions, followed by gathering the corrections from the reviewers and updating the ASR model. ASR engine 104 may then continue to transcribe the audio signal at further enhanced accuracy.

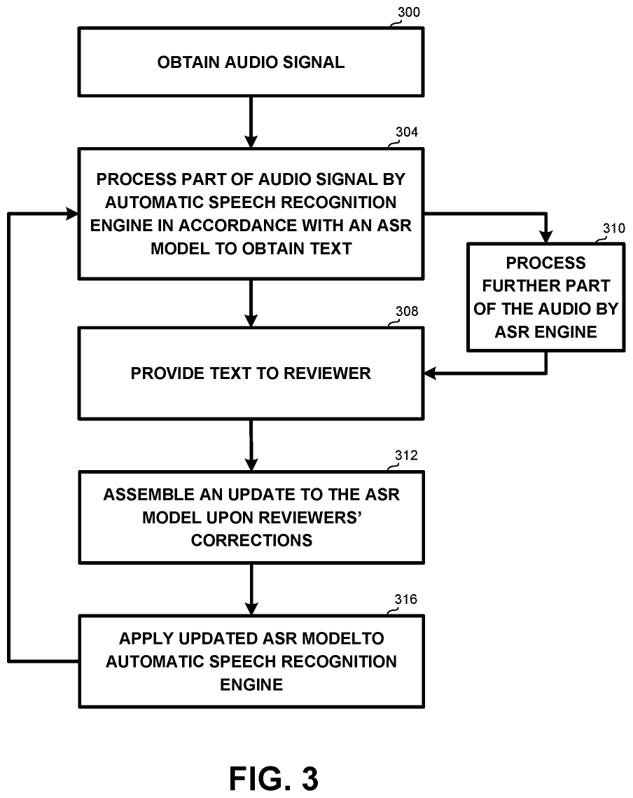

Referring now to FIG. 3, showing a flowchart of steps in a method for generating text from audio, in accordance with some exemplary embodiments of the disclosure.

On step 300, an audio signal may be obtained, for example captured, downloaded, received as a stream, or the like. If the audio signal is analog, it may be digitized to obtain a digital audio signal.

On step 304, a part of the audio signal, wherein the part of the audio signal is partial to the audio signal, may be processed by an ASR engine, to obtain partial text representing the part of the audio signal. The ASR engine may use an ASR model associated with a vocabulary. The vocabulary may be general, domain-specific, or the like.

On step 308, the partial text may be provided to one or more reviewers. At least one of the reviewers may be a human reviewer, or at least one of the reviewers may be another automated process.

While the reviewers are reviewing their assigned texts, on step 310 the ASR engine may keep transcribing further parts of the audio, such that when any of the reviewers is done reviewing the relevant segment, the idle time is reduced or eliminated and the reviewer can continue reviewing the further part or a subpart thereof.

On step 312, an update to the ASR model may be assembled upon the reviewers' corrections. Depending on the specific implementation, the update may be a new ASR model, a new component of an ASR model, an addition to the ASR model, or the like. The update to the ASR model may comprise information from one or more corrected words, words misrecognized by the ASR engine, updated probabilities of one or more words to appear in the audio, or the like.

In some embodiments, a vocabulary update to the ASR model may be obtained by an automated process. For example, the automated process may compare the text provided by the ASR engine to the text provided by the reviewers, to detect differing words that relate to the same spoken word. Some ASR engines associate a certainty level with each recognized word. Thus, in some embodiments, the automated process may compare only words for which the certainty of the ASR engine is below a predetermined threshold with the corresponding word in the reviewed text, or the like. In some embodiments, if the same spoken word, as recognized for example using its phonemes, repeats in segments assigned to different reviewers, the reviewers' corrections, if any, to the word may be compared. If the reviewers corrected the word differently, the word which was provided by the majority of reviewers may be selected over the other options.

The probabilities of words to appear within the audio signal may be provided by the reviewers, or calculated, for example by applying the Term Frequency-Inverse Document Frequency (TF-IDF) methodology or a similar methodology that takes into account the relative frequency of the word or short phrase in different texts, including the ones being transcribed. In other embodiments, pre-fixed weights may be added to the terms introduced by the reviewers. In further embodiments, the weights may be calculated based on perplexity or on how many times the term was corrected. For example, if the word has been corrected a few times but is still not recognized, or based on frequency in language or indeed also on TF-IDF or similar methodology that takes into account the relative frequency of the word or short phrase in different texts including the one we are transcribing.

On step 316, the updated ASR model may be applied, such that the ASR engine uses the newly assembled model, instead of or in addition to the previously used model. Using the new model, the ASR engine may thus recognize words that have not been recognized well by the previous model.

In some embodiments and depending on the specific implementation, steps 312 and 316 may be performed together, for example the ASR engine may automatically start using an updated ASR model, such that assembling of the ASR model may automatically cause it to be applied.

The ASR engine may then return to step 304 to continue processing further segments of the audio, using the updated ASR model, which may provide more accurate text than before the ASR model has been updated.

The method may repeat wherein the ASR model is being further updated as more text is reviewed by the reviewers.

Scheduling of the automatic transcription may be designed in accordance with the tradeoff between the transcription accuracy and the reviewers' time efficiency. For example, in order to improve the accuracy as much as possible, the ASR may transcribe short segments, and no further transcription may take place until the reviewers finished their review and the model was updated. Under this scheme, the reviewers have to wait for the next segments to be available, but the model is updated often and may thus improve quickly. This scheme may be useful where the text is presented, for example to TV audience, prior to being reviewed, where the highest priority is to have the most accurate ASR as soon as possible.

On the other hand, if the goal is to make the best utilization of the reviewers' time, further segments may be transcribed using the previous model such that the segments will be available to the reviewers as soon as they finished their previous tasks. Under this scheme, longer parts of the audio will be transcribed at less-updated models, but the reviewers' time is fully utilized. The exact scheduling which provides as late as possible transcription (such that the most updated model is used) while keeping the reviewers busy may be created to provide the best compromise for the specific application or specific organization. For example, a buffer of the audio signal that has been transcribed but not yet provided to the reviewer may be maintained, wherein the buffer being is of a duration of between a first threshold and a second threshold.

The following is a schematic numerical example for such scheduling.

Given an audio signal, minutes 1-5 thereof are transcribed by an ASR engine.

The text is provided to 5 reviewers, each reviewing an audio part of one minute and the associated transcription.

Meanwhile, the ASR engine is transcribing minutes 6-10.

When the reviewers have finished reviewing minutes 1-5, the reviewers proceed to review the transcription of minutes 6-10, and at the same time the ASR model is updated according to the corrections introduced regarding minutes 1-5, and proceeds to transcribe minutes 11-15 using the updated ASR model.

It is appreciated that the numbers above are exemplary only, and are merely intended to illustrate the principle of applying updates to the ASR model, by keeping the reviewers busy by always (or as much as possible) having ready-to-review parts of the audio. The selected durations may depend on the actual pace of the transcribers, the cost and turn-around time, and other considerations.

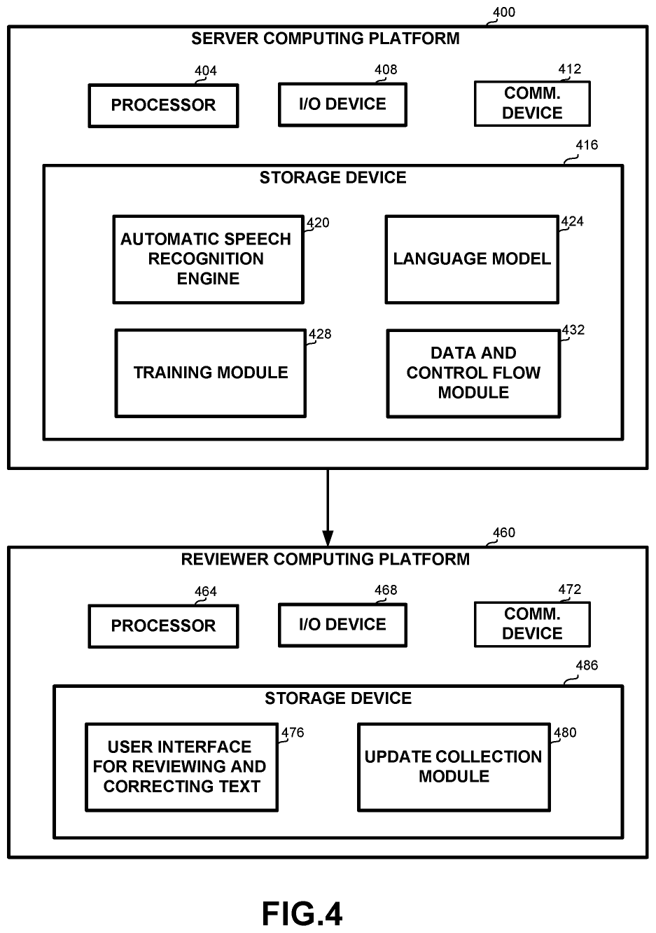

Referring now to FIG. 4, showing a block diagram of a system for generating text from audio, in accordance with some exemplary embodiments of the disclosure.

The apparatus may comprise one or more server computing platforms 400 and/or one or more reviewer computing platforms 460. In some embodiments, server computing platform 400 and reviewer computing platforms 460 may be remote from each other and may communicate via any communication channel such as the Internet, Intranet, Local Area Network (LAN), Wide Area Network (WAN), or the like. However, in other embodiments, server computing platform 400 and reviewer computing platforms 460 may be implemented on one device, such as a server, wherein the user's computing platform may be implemented as a web application executed by the same computing platform or a different one.

Server computing platform 400 may comprise a processor 404. Processor 404 may be a Central Processing Unit (CPU), a microprocessor, an electronic circuit, an Integrated Circuit (IC) or the like. Processor 404 may be utilized to perform computations required by the apparatus or any of its subcomponents. Processor 404 may be implemented as one or more central processing units (CPUs), a microprocessor, an electronic circuit, an Integrated Circuit (IC) or the like. Processor 404 may be configured to provide the required functionality, for example by loading to memory and activating the modules stored on storage device 416 detailed below or perform steps of FIG. 3 above.

In some exemplary embodiments of the disclosed subject matter, server computing platform 400 may comprise an Input/Output (I/O) device 408 such as a display, a pointing device, a keyboard, a touch screen, a speaker, a microphone, or the like. I/O device 408 may be utilized to provide output to and receive input from a user.

In some exemplary embodiments of the disclosed subject matter, server computing platform 400 may comprise communication device 412 such as a network adaptor, enabling server computing platform 400 to communicate with other platforms such as one or more reviewer computing platforms 460.

In some exemplary embodiments, server computing platform 400 may comprise a storage device 416. Storage device 412 may be a hard disk drive, a Flash disk, a Random Access Memory (RAM), a memory chip, or the like. In some exemplary embodiments, storage device 416 may retain program code operative to cause processor 404 to perform acts associated with any of the subcomponents of the apparatus. The components detailed below may be implemented as one or more sets of interrelated computer instructions, executed for example by processor 404 or by another processor. The components may be arranged as one or more executable files, dynamic libraries, static libraries, methods, functions, services, or the like, programmed in any programming language and under any computing environment.

Storage device 416 may store, or be in operative communication with another storage device storing ASR models for one or more languages, dialects, verticals, subjects or the like, one or more vocabularies, or the like.

Storage device 416 may store ASR engine 420, operating in accordance with ASR model 424. ASR model 424 may be periodically updated with a vocabulary update based on input from the reviewers.

Storage device 416 may store training module 428 for training an ASR engine and/or ASR model.

Storage device 416 may store data and control flow module 432, for activating various functionalities, providing each with the required input and receiving the output. For example, data and control flow module 432 may be configured to split the audio to parts, provide the parts to the ASR engine and receive the transcription, provide each part and the corresponding transcription to a reviewer, receive the corrected text or other indications from the reviewers, unify the corrections, update the language model, and collect the corrected text from the reviewers as the final transcription of the audio signal.

Reviewer computing platform 460 may comprise a processor 464, I/O device 468, or communication device 472, functionally similar to comparable components as described above for server computing platform 400. Reviewer computing platform 460 may comprise storage device 486 as described above for storage device 416 of server computing platform 400.

Storage device 486 of reviewer computing platform 460 may store user interface for reviewing and correcting text 476. The reviewer may view the automatic transcription while listening to the audio or viewing the video while listening to the audio, and may edit the text including changing one or more words, adding or deleting words, or the like. The user interface may provide for highlighting the text words that correspond to the words that are being played by an audio device such as a speaker, headphones, or the like.

In some embodiments, user interface 476 may provide for the user to enter one or more words, associated frequencies, or the like.

Storage device 486 of reviewer computing platform 460 may store update collection module 480 for comparing the text provided to the reviewer and the enhanced text to retrieve words that need to be updated, calculating frequencies of words, or the like. In some embodiments, the corrections or text by the reviewer may be provided as is to server computing platform 400, which may perform the correction collection for all the texts provided by the reviewers.

The present disclosed subject matter may be a system, a method, and/or a computer program product. The computer program product may include a computer readable storage medium (or media) having computer readable program instructions thereon for causing a processor to carry out aspects of the disclosed subject matter.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the disclosed subject matter may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the disclosed subject matter.

Aspects of the disclosed subject matter are described herein with reference to flowchart illustrations and/or block diagrams of methods, apparatus (systems), and computer program products according to embodiments of the disclosed subject matter. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the disclosed subject matter. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the disclosed subject matter has been presented for purposes of illustration and description, but is not intended to be exhaustive or limited to the invention in the form disclosed. Many modifications and variations will be apparent to those of ordinary skill in the art without departing from the scope and spirit of the disclosed subject matter. The embodiment was chosen and described in order to best explain the principles of the disclosed subject matter and the practical application, and to enable others of ordinary skill in the art to understand the disclosed subject matter for various embodiments with various modifications as are suited to the particular use contemplated.

What is claimed is:

1. A method for transcribing audio signals, comprising:
obtaining an audio signal;
processing by an automatic speech recognition (ASR) engine a part of the audio signal shorter than the audio signal, to obtain a partial text representing the part of the audio signal, said processing performed in accordance with an ASR model;
providing the part of the audio signal and the partial text to a reviewer;
assembling an ASR model update, based on input from the reviewer;
applying the ASR model update to the ASR engine; and
processing at least a second part of the audio signal by the ASR engine using the ASR model as updated, to obtain a further partial text of the audio signal.

2. The method of claim 1, further comprising maintaining a buffer of the audio signal processed by the transcriber and not yet provided to the reviewer, the buffer being of a duration of at least a first threshold to ensure that a transcribed part is available to the reviewer.

3. The method of claim 1, further comprising maintaining a buffer of the audio signal processed by the transcriber and not yet provided to the reviewer, the buffer being of a duration of at most a second threshold, to enable processing of further parts of the audio signal by the ASR engine as updated.

4. The method of claim 1, wherein the reviewer comprises at least one human.

5. The method of claim 1, wherein the reviewer comprises at least two human reviewers, and wherein the input from the reviewer comprises text updates from the at least two human reviewers.

6. The method of claim 1, wherein the text updates relate to at least one word misrecognized by the transcriber.

7. The method of claim 1, wherein the text updates relate to one or more items selected from the group consisting of: at least one word recognized by the transcriber not frequently enough; at least one spelling correction, at least one pronunciation correction, and at least one formatting correction.

8. The method of claim 1, wherein the partial text is corrected by the reviewer to obtain a corrected text.

9. The method of claim 8, wherein the ASR model update is retrieved automatically from the corrected text.

10. The method of claim 1, wherein upon receiving the update ASR model or upon completion of review of the at least one part by the reviewer, the ASR engine transcribes at least an additional part of the audio signal.

11. The method of claim 1, further comprising applying said processing, said providing, said obtaining and said applying to further parts of the audio signal.

12. The method of claim 1, wherein said processing comprises transcribing the part of the audio signal or generating captions for the part of the audio signal.

13. The method of claim 1, further comprising providing the ASR model update by an automated process using an Application Program Interface.

14. The method of claim 1, wherein the ASR model comprises at least one item selected from the group consisting of: a language model, a specific vocabulary model, an acoustic model, a pronunciation model, and a combination of two or more of the above.

15. A system having a processor, the processor being adapted to perform the steps of: obtaining an audio signal;
processing by an automatic speech recognition (ASR) engine a part of the audio signal shorter than the audio signal, to obtain a partial text representing the part of the audio signal, said processing performed in accordance with an ASR model;
providing the part of the audio signal and the partial text to a reviewer;
assembling an ASR model update, based on input from the reviewer;
applying the ASR model update to the ASR engine; and
processing at least a second part of the audio signal by the ASR engine using the ASR model as updated, to obtain a further partial text of the audio signal.

16. The system of claim 15, wherein the processor is configured to maintain a buffer of the audio signal processed by the transcriber and not yet provided to the reviewer, the buffer being of a duration of at least a first threshold to ensure that a transcribed part is available to the reviewer.

17. The system of claim 15, wherein the processor is configured to maintain a buffer of the audio signal processed by the transcriber and not yet provided to the reviewer, the buffer being of a duration of at most a second threshold, to enable processing of further parts of the audio signal by the ASR engine as updated.

18. The system of claim 15, wherein the reviewer comprises at least two human reviewers, and wherein the input from the reviewer comprises text updates from the at least two human reviewers.

19. The method of claim 15, wherein the text updates relate to one or more items selected from the group consisting of: at least one word misrecognized by the transcriber; at least one word recognized by the transcriber not frequently enough; at least one spelling correction, at least one pronunciation correction, and at least one formatting correction.

20. A computer program product comprising a non-transitory computer readable medium retaining program instructions, which instructions when read by a processor, cause the processor to perform:
obtaining an audio signal;
processing by an automatic speech recognition (ASR) engine a part of the audio signal shorter than the audio signal, to obtain a partial text representing the part of the audio signal, said processing performed in accordance with an ASR model;
providing the part of the audio signal and the partial text to a reviewer;
assembling an ASR model update, based on input from the reviewer;
applying the ASR model update to the ASR engine; and
processing at least a second part of the audio signal by the ASR engine using the ASR model as updated, to obtain a further partial text of the audio signal.
